(19) United States
(12) Patent Application Publication
(10) Pub. No.: US 2020/0309569 A1
(43) Pub. Date: Oct. 1, 2020

(54) POSITIONING MOTORS BY MEANS OF CAPACITIVE MEASURING

(71) Applicant: Webasto SE, Stockdorf (DE)

(72) Inventors: ENRICO EHRICH, Stockdorf (DE); JANI HOVAN, Stockdorf (DE)

(21) Appl. No.: 16/760,083

(22) PCT Filed: Nov. 9, 2018
(86) PCT No.: PCT/EP2018/080792

§ 371 Date: Apr. 29, 2020

(30) Foreign Application Priority Data
Nov. 9, 2017 (DE) 10 2017 126 271.7

(51) Int. Cl. G01D 5/24; G01P 3/483

(52) U.S. Cl. CPC G01D 5/24; G01P 3/483

(57) ABSTRACT

A measuring arrangement and corresponding method for determining the rotational position, speed and/or direction of rotation of a shaft, in particular of an electric motor of an electromotively adjustable device of a vehicle. The measuring arrangement comprises at least first and second electrodes which each form capacitor elements, wherein an electrical voltage can be applied to the electrodes to generate an electric field (EF); a rotatable shaft, in particular a motor shaft, having a measuring section which has an out-of-roundness, wherein the measuring section is arranged relative to the electrodes such that a rotation of the shaft changes the electric field (EF); and an evaluation unit which is conductively connected to an electrode to capacitively capture a change in the electric field (EF), in particular in the form of a change in a voltage applied to an electrode.

This application represents the national stage entry of PCT International Application No. PCT/EP2018/080792 filed Nov. 9, 2018, which claims priority to German Patent Application 10 2017 126 271.7 filed Nov. 9, 2017, both of which are hereby incorporated herein by reference for all purposes.

The disclosure relates to a measuring arrangement and to a method for determining the rotational position, speed and/or direction of rotation of a shaft, in particular of an electric motor of an electromotively adjustable device of a vehicle, such as a sliding roof, a window lifter, an exterior mirror, a seat, a convertible roof or a locking mechanism.

A multiplicity of electric motors are installed in modern vehicles, for example for the purpose of driving pumps or fans and for actuating electromotively adjustable devices of a vehicle, for example a window lifter, an exterior mirror or a seat. In order to control said vehicle devices, a multiplicity of sensors for automatically capturing the position and speed of the rotational movement of the respective drive motor are nowadays installed in vehicles. Contactless sensors for capturing the rotational position and rotational speed of a drive or output shaft of an electric motor are known from the prior art.

Use is often made of Hall sensors which contactlessly capture the rotational movement of a shaft on the basis of the physical Hall effect in interaction with a sensor through which current flows and which has a magnetic field. The magnetic field is usually generated by a permanent magnet, for example a magnetic wheel, which is fitted to the shaft, the rotational movement of which is intended to be captured. Two Hall sensors are often used in order to be able to also capture the direction of rotation of the shaft in addition to the (incremental) rotational position and rotational speed or speed. Such sensor arrangements have the disadvantage that they are relatively complicated and expensive. In addition to the Hall sensors and a magnetic wheel in the motor, additional electronic components on a separate circuit board are required.

Contactless methods for determining the rotational position and rotational speed for DC motors are also known from the prior art and are based on capturing the ripple current through the armature of a DC motor. In this case, the current ripples of the armature current which are generated by the rotation of the motor are counted by means of evaluation electronics without sensors (“ripple counting”). The disadvantage of this measuring method is that this method is relatively complicated, in particular with regard to the required processing of the required measurement signal and the computing power of the evaluation electronics.

On the basis of this prior art, the object of the present disclosure is to provide a measuring arrangement for determining the rotational position, speed and/or direction of rotation of a shaft, which measuring arrangement can be implemented in a simpler manner, in particular with less outlay with regard to the installed components, and a corresponding method. In particular, the intention is to be able to determine the rotational position, rotational speed and/or direction of rotation of the shaft as cost-effectively as possible, but as reliably and accurately as possible at the same time.

Said object is achieved by means of a measuring arrangement according to claim 1, a method according to claim 14 and a use according to claim 15.

In particular, the object is achieved by means of a measuring arrangement for determining the rotational position, speed and/or direction of rotation of a shaft, in particular of an electric motor of an electromotively adjustable device of a vehicle, comprising:
at least one first electrode and at least one second electrode which each form capacitor elements;
wherein an electrical voltage can be applied to the electrodes in such a manner that the electrodes generate an electric field;
a rotatable shaft, in particular a motor shaft, having a measuring section which has an out-of-roundness,
wherein the measuring section is arranged relative to the electrodes in such a manner that a rotation of the shaft changes the electric field;
an evaluation unit which is conductively connected to an electrode and is designed to capacitively capture a change in the electric field, in particular in the form of a change in a voltage applied to an electrode.

In the most general sense of the disclosure, an out-of-roundness can be understood as meaning a deviation of the perimeter of the measuring section of the shaft from an ideally round circumference in sections perpendicular to the shaft axis provided that the extent of the out-of-roundness is sufficiently large to cause a measurable change in the electric field in the case of a given configuration of the measuring arrangement. In particular, in a situation in which the measuring section is arranged closer to the electrodes, a smaller out-of-roundness can suffice for the measurable change in an electric field than in a situation in which the measuring section is arranged further away from the electrodes. In a narrower sense of the disclosure, pure manufacturing tolerances of a measuring section which is only approximately round on account of manufacturing could not be understood as meaning an out-of-roundness according to the disclosure. An out-of-roundness can be produced, in particular, by an eccentricity relative to the shaft axis or by a shaft profile having a cross section which is not rotationally symmetrical.

A first electrode and a second electrode preferably together respectively form an electrode pair which forms, in particular, two capacitor elements which form a capacitor having a particular electrical capacitance. A plurality of electrode pairs may be provided. In particular, there is capacitive coupling between a first electrode and a second electrode. A change according to the disclosure in the electric field can be capacitively captured, in particular, insofar as the change caused in the electric field is sufficiently large to cause a measurable change in the capacitance of a capacitor. The electric field is, in particular, an electrostatic field which is preferably generated in the environment of the electrodes. In particular, as a result of a rotation of the shaft, it is possible to measure a cyclical change in the electric field, in particular with respect to a reference state which can be understood as meaning an unchanged electric field. The evaluation unit is designed, in particular, to determine a rotational position, speed and/or direction of rotation of the shaft on the basis of the captured change in the electric field. In particular, the evaluation unit captures the number of changes in the electric field, which are produced by the unevenness of the shaft, or the capacitance changes which are caused, preferably over time, in order to calculate a rotational position or speed or rotational speed therefrom. The evaluation unit can be designed to implement different capacitive capture or measuring methods using apparatus and/or process technology, preferably by means of a suitable evaluation circuit which preferably comprises electronic and/or electrical components or assemblies.

In particular, a change in the electric field can be capacitively captured by capturing a voltage or a voltage change applied to an electrode, for example in a similar manner to that in a projective-capacitive measuring method which is usually used for touchscreens. In this case, a voltage, for example in the form of voltage pulses, can be applied to a first electrode, in particular in the form of a transmitting or driver electrode, and a voltage can be tapped off at a second electrode, in particular in the form of a receiving electrode. In this case, a capacitance change in the capacitor formed by the electrodes can cause a (measurable) voltage change, preferably at the receiving electrode, as a result of a change in the electric field. Alternatively, a change in the electric field can be capacitively captured by capturing a changed resonant behaviour of a capacitor formed by the electrodes. For this purpose, a capacitor can be connected to an inductance to form a resonant circuit. For example, a frequency shift or a phase shift, preferably of a voltage applied to an electrode, can be captured.

A rotational position can be understood as meaning both an angle change (incremental value) and an absolute angle (absolute value). In addition to or instead of the speed, it is also possible to determine the rotational speed. The shaft and the measuring section can each be implemented in one part or several parts, in which case the measuring section can be implemented in one part with the shaft or can be connected to the shaft as a separate component in a rotationally fixed manner. The electrodes are preferably arranged in a stationary manner relative to the rotatable shaft. The electrodes or the capacitor elements can be adapted to the shape of the shaft or of the measuring section. For example, the capacitor elements of the electrodes may have sections which are in the form of circle segments and preferably approximately have a radius of a circumference of the measuring section. The measuring section is preferably electrically conductive but may, in principle, also be made from a dielectric material provided that a rotation of the shaft causes a (measurable) change in the electric field. The measuring arrangement preferably comprises a microcontroller which is conductively connected, preferably electrically, to at least one electrode and/or to the evaluation unit, in particular. The evaluation unit and the microcontroller may form a unit, in which case the microcontroller can be integrated in the evaluation unit or vice versa. The evaluation unit can be designed to execute an algorithm for calculating the rotational position, speed and/or direction of rotation, in particular on the basis of an implemented computer program.

The disclosure is based on the idea of capacitively capturing a change in an electric field caused by a rotation of a shaft in order to determine the rotational position, rotational speed and/or direction of rotation of the shaft therefrom. By virtue of the fact that the shaft has a measuring section with an out-of-roundness, a rotation of the shaft in an electric field produces a change in this field which can be understood as meaning, in particular, a local deformation of the field lines or a change in the field strength. In particular, the change in the electric field is greater, the greater the out-of-roundness and the greater the field line density, through which the out-of-roundness moves. For example, in the case of a constant speed of the shaft and precisely one out-of-roundness over the circumference of the shaft, for example a single radial measuring elevation, precisely one change in the electric field is caused for each revolution, which change is capacitively captured, preferably counted, by the evaluation unit. A rotation of the shaft preferably results in periodic changes in the electric field. An increase in the rotational speed of the shaft would result in an increase in the frequency of the changes in the electric field. A measuring arrangement according to the disclosure makes it possible to contactlessly determine the rotational position, speed and/or direction of rotation of a shaft in a manner which can be easily implemented. In comparison with the prior art, it is possible to dispense with a magnetic wheel and Hall sensors. It is also possible to capacitively capture the changes in the electric field with little outlay on circuitry. As a result, the measuring arrangement is cost-effective and is suitable for applications with a large number of parts, in particular for use for different electromotively actuated devices in vehicles, such as for sliding roofs, window lifters, exterior mirrors, seats, convertible roofs or locking mechanisms.

In one advantageous development of the disclosure, at least two electrode pairs each comprising first and second electrodes are provided, wherein a first electrode pair, in particular, is designed to determine the rotational position and/or speed of the shaft and a second electrode pair, in particular, is designed to determine the direction of rotation of the shaft. A plurality of electrode pairs which are preferably arranged in a manner distributed over the circumference of the measuring section have the advantage that the rotational position and/or the speed can be determined in a more accurate manner. A second electrode pair has the advantage, in particular, that the direction of rotation of the shaft can be determined. For example, the direction of rotation can be determined by capturing the sequence of a change in the electric field, which change is preferably caused by the same unevenness of the measuring section and is captured by two different electrode pairs in a temporally offset manner.

In one advantageous development of the disclosure, the measuring section of the shaft has a shaft profile which is not rotationally symmetrical, in particular a shaft profile which is point-symmetric with respect to the shaft axis, preferably with at least one radial measuring elevation. A shaft profile is, in particular, a cross-sectional profile of the shaft, preferably perpendicular to the shaft axis. During rotation of the shaft, a shaft profile describes, in particular, a circumferential crown circle (larger radius) and a circumferential root circle (smaller radius). During any desired rotation about the shaft axis, a shaft profile which is not rotationally symmetrical cannot be congruently blended together, with the result that there is an unevenness in the sense of the disclosure as a result of the lack of rotational symmetry. Such an out-of-roundness of the measuring section can be formed by individual radial measuring elevations, for example in the form of a radial recess, a radial projection, a notch, an axial groove or an eccentrically fastened element, such as a screw, an overlay weld, a feather key, an element plugged on the shaft or through the shaft. A plurality of radial measuring elevations may also be provided. The shaft profile may be, for example, a toothed profile or a polygonal profile. A shaft profile which is point-symmetric with respect to the shaft axis has the advantage that the shaft or the measuring section does not have any imbalance.

In one advantageous development of the disclosure, the shaft profile has radial measuring elevations distributed, preferably uniformly distributed, over the circumference. Such a shaft profile enables a higher sampling frequency of the rotational movement of the shaft since a plurality of changes in the electric field are caused for each revolution of the shaft. In particular, the number of captured changes corresponds to the number of measuring elevations. As a result, the accuracy with which the rotational position and/or speed is/are determined is increased, in particular during phases in which the speed varies.

In one advantageous development of the disclosure, at least two measuring elevations extend to a different degree in the radial direction. The distances between an end point of a measuring elevation and the shaft axis are preferably different in each case. In particular, different circumferential crown circles can be assigned to different measuring elevations. In particular, precisely one measuring elevation could extend further in the radial direction than the other measuring elevations. This makes it possible to correct measurement errors, in particular, for example if one of the measuring elevations is not captured or concomitantly counted on account of a measurement error or a disturbance variable. For example, as a result of an individual higher measuring elevation, it would still be possible to assign a captured measurement signal to a revolution of the shaft. An ambiguity of the assignment of a captured change in a measuring elevation to an electrode pair, in particular when determining the direction of rotation, can also be resolved thereby. The reliability of the measuring arrangement would be increased as a result.

In one advantageous development of the disclosure, the shaft profile is a toothed profile or a polygonal profile, wherein the shaft profile preferably has 2 to 16, more preferably 2 to 12, more preferably 2 to 8, more preferably 2 to 6, for example 2, 3 or 4, radial measuring elevations. In the case of a toothed profile, the individual teeth each form a radial measuring elevation. In the case of a polygonal profile, the edges of the polygonal cross section each form a measuring elevation. The higher the number of measuring elevations, the higher the sampling or capture frequency (measuring frequency) of the measuring arrangement.

In one advantageous development of the disclosure, the shaft axis is arranged parallel to a central plane of the electrodes, preferably perpendicular to an electrode plane in which the electrodes are arranged. An electrode plane is defined, in particular, by a plane in which capacitor elements of the electrodes which are preferably flat, for example in the form of plates or in the form of electrode pads, extend. The shaft can be arranged between the electrodes or laterally offset with respect to the latter.

In one advantageous development of the disclosure, the measuring arrangement comprises a printed circuit board on which the electrodes, and preferably the evaluation unit, are arranged. The printed circuit board defines the electrode plane, in particular. The printed circuit board is preferably in the form of an electronic circuit board on which the electrodes and preferably the evaluation unit are fastened and are preferably connected to one another in an electrically conductive manner by means of conductor tracks. As a result of a printed circuit board, the measuring arrangement can be (partially) preassembled and can be easily positioned relative to the shaft in order to assemble the measuring arrangement according to the disclosure.

In one advantageous development of the disclosure, the printed circuit board has a measuring recess, preferably a circular measuring recess, wherein the measuring section of the shaft, in particular, extends into the measuring recess, preferably projects through the measuring recess. The shaft axis runs, in particular, perpendicular to the electrode plane. This makes it possible to achieve a flat design of the measuring arrangement. In addition, the intended positioning of the shaft relative to the electrodes can be easily complied with during assembly. The electrodes can project beyond the measuring recess, preferably inwards towards the measuring section.

In one advantageous development of the disclosure, the measuring arrangement comprises a microcontroller which is designed, in particular, to supply an electrode with a DC voltage, preferably a pulsed DC voltage. A constant pulsating DC voltage is preferably applied to one of the electrodes (transmitter or driver electrode). Another electrode can be connected to earth, for example. A square-wave voltage having a voltage amplitude of 0 V and 5 V is used, for example. Depending on the capacitive measuring method used, embodiments are also possible in which an AC voltage is applied to an electrode or an electrode pair.

In one advantageous development of the disclosure, the evaluation unit comprises a filter unit, preferably a bandpass filter, which is designed, in particular, to allow a frequency band of a captured measurement signal to pass through. The frequency band is preferably adjustable, in particular on the basis of the current speed of the shaft. A filter unit has the advantage that interference, for example in the form of harmonics, can be filtered out of the captured measurement signal. As a result, the reliability of the measuring arrangement would be increased.

In one advantageous development of the disclosure, the measuring section, in particular the shaft, is electrically conductive, in particular is made from a metallic material. An electrically conductive measuring section has the advantage that the change in the electric field as a result of the out-of-roundness is relatively large and can be measured well as a result.

In one advantageous development of the disclosure, the shaft is a motor output shaft, in particular of an electric motor, preferably of an electromotively adjustable device of a vehicle, such as a sliding roof, a window lifter, an exterior mirror, a seat, a convertible roof or a locking mechanism.

The object is also achieved, in particular, by means of a method for determining the rotational position, speed and/or direction of rotation of a shaft, in particular of an electric motor of an electromotively adjustable device of a vehicle, in particular with a measuring arrangement according to the disclosure, comprising the following steps of:
a) providing at least one first electrode and at least one second electrode which each form capacitor elements;
b) applying a voltage to the electrodes in order to generate an electric field;
c) rotating a shaft, in particular a motor shaft, which has a measuring section with an out-of-roundness,
   wherein the measuring section is arranged relative to the electrodes in such a manner that a rotation of the shaft changes the electric field;
d) capturing the change in the electric field by means of a capacitive measurement using an evaluation unit which is conductively connected to an electrode, in particular by capturing a change in a voltage applied to an electrode;
e) determining the rotational position, speed and/or direction of rotation of the shaft by means of the evaluation unit on the basis of the captured change in the electric field.

The method has similar advantages to those already described in connection with the measuring arrangement according to the disclosure and can implement some or all process technology features described in connection with the measuring arrangement.

The shaft, preferably the motor output shaft, is rotated, in particular, by actuating an electric motor, in particular of an electromotively adjustable device of a vehicle. In particular, the number of changes in the electric field which are produced by the unevenness of the shaft or the capacitance changes which are caused is captured, preferably over time, in order to calculate a rotational position or speed therefrom. The evaluation unit can be designed to implement different capacitive capture or measuring methods using apparatus and/or process technology, preferably by means of a suitable evaluation circuit.

The object is also achieved, in particular, by the use of a measuring arrangement according to the disclosure for determining the rotational position, speed and/or direction of rotation of a shaft of an electric motor of an electromotively adjustable device of a vehicle, such as a sliding roof, a window lifter, an exterior mirror, a seat, a convertible roof or a locking mechanism. The measuring apparatus according to the disclosure can be implemented in a simple manner, in particular in a cost-effective manner, and is suitable, in particular, for use for applications having a large number of parts, such as for electromotively adjustable devices in vehicles.

Exemplary embodiments of the disclosure are explained in more detail below on the basis of the drawings, in which:

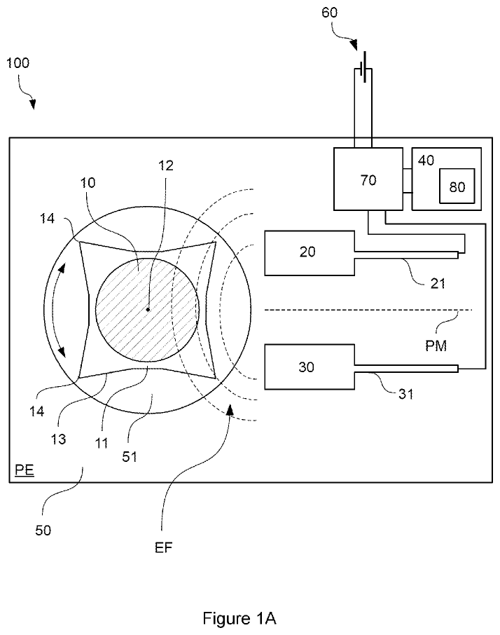

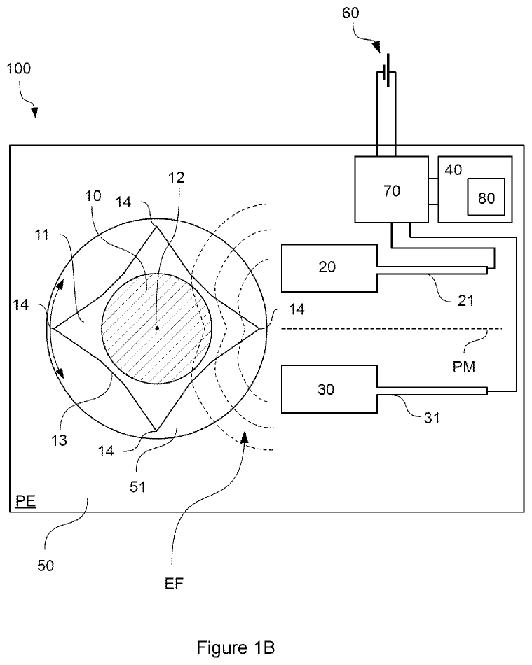

FIG. 1A shows a schematic illustration of a first embodiment of a measuring arrangement according to the disclosure, wherein the shaft is in a first rotational position;

FIG. 1B shows a schematic illustration of the embodiment according to FIG. 1A, wherein the shaft is in a second rotational position;

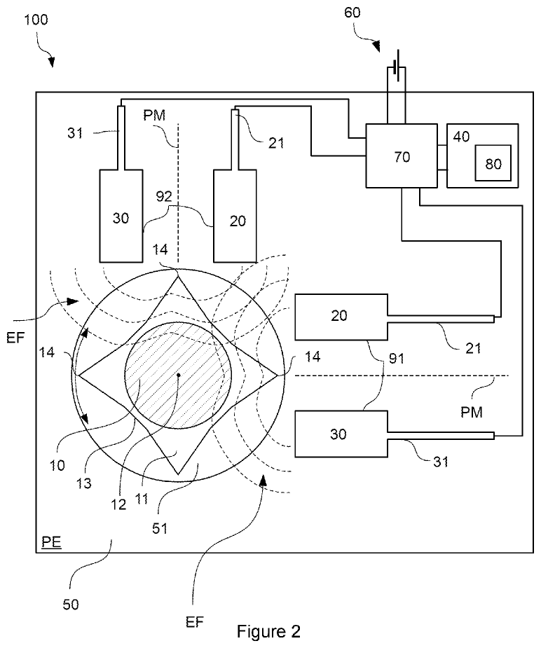

FIG. 2 shows a schematic illustration of a second embodiment of a measuring arrangement according to the disclosure having two electrode pairs.

In the following description of the disclosure, the same reference signs are used for identical and identically acting elements.

FIGS. 1A and 1B show a measuring arrangement 100 according to the disclosure for determining the rotational position, speed and/or direction of rotation of the rotatable shaft 10 in a first and a second rotational position. A first electrode 20 and a second electrode 30, which each form capacitor elements, are arranged in an electrode plane PE in a symmetrical manner with respect to a central plane PM (perpendicular to the electrode plane PE or plane of the drawing in the figures). The electrodes 20, 30 form capacitor elements which are flat at the ends and are formed here, in the form of plates with a rectangular basic shape, from a conductive, in particular metallic, material, for example copper. The shaft axis 12 of the shaft 10 is perpendicular to the electrode plane PE and runs in the central plane PM. An electrical voltage is applied to the electrodes 20, 30 and generates, in the environment of the electrodes 20, 30, an electric field EF, the field lines of which are indicated as dashed lines. FIG. 1A illustrates the electric field EF in a reference state, that is to say substantially without interference, whereas FIG. 1B illustrates it in a changed or disrupted state, which is illustrated, in particular, by the deformed field lines.

The shaft 10 has a measuring section 11 with an out-of-roundness in the form of the shaft profile 13 which is not rotationally symmetrical but is point-symmetric. The unround shaft profile 13 of the measuring section 11 projects here radially beyond the circular cross section of the shaft 10 which is illustrated in section, but could also radially recoil with respect to the cross section of the shaft 10 or could be formed in a manner radially flush with the shaft 10. The shaft 10 and the measuring section 11 are made from metal here, that is to say are electrically conductive, in particular. The shaft profile 13 is in the form of a toothed profile which has four measuring elevations 14 which are uniformly distributed over the circumference. The measuring section 11 is arranged in such a manner that the measuring elevations 14, as out-of-roundnesses according to the disclosure interact with the electric field EF, in particular if a measuring elevation 14 passes the electrodes 20, 30 on account of a rotational movement of the shaft 10, as illustrated in FIG. 1B. A change in the electric field EF is caused by the rotation of the unround measuring section 11.

The electrodes 20, 30 are arranged on a printed circuit board 50 which is made from an electrically insulating material, for example from plastic, and has a circular measuring recess 51 into which the measuring section 11 extends. The electrodes 20, 30 are conductively connected, via conductor tracks 21 and 31, to a microcontroller 70 which is in turn conductively connected to an evaluation unit 40 and is supplied with electrical power by a voltage source 60. The microcontroller 70 and the evaluation unit 40, which comprises a filter unit 80, preferably a bandpass filter, are likewise arranged on the printed circuit board 50.

In the case of a rotation of the shaft 10, which is connected to the measuring section 11 in a rotationally fixed manner or in one part, each out-of-roundness of the measuring section 11 causes a change in the electric, preferably electrostatic, field EF which is generated in the environment of the electrodes 20, 30. This change in the electric field EF can be capacitively captured, as a capacitance change of the capacitor formed by the electrodes 20, 30 together, by the evaluation unit 70. For example, a voltage, preferably a uniformly pulsed DC voltage, for example in the form of square-wave pulses with a voltage amplitude of 0 V and 5 V, is applied to the first electrode 20 through an output of the microcontroller 70. A corresponding electric field EF is generated. If a measuring elevation 14 moves through the electric field EF, that is to say rotates through the electric field, the result is a change in the capacitance of the capacitor formed by the capacitor elements of the electrodes 20, 30. This capacitance change can be measured, for example by means of a voltage change at the second electrode 30, which can be tapped off at an input of the microcontroller 70. The evaluation unit 40, which could also be integrated in the microcontroller 70, captures the change in the electric field EF as a countable signal change or fluctuation, in particular in the form of a rise or fall in a voltage signal. The rotational position and/or the speed of the shaft 10 can be determined by capturing the number of changes, in which case the number of available measuring elevations 14 of the measuring section 11 is preferably stored in the evaluation unit 40.

FIG. 2 shows an embodiment of a measuring arrangement 100 according to the disclosure having two electrode pairs 91, 92 each with first electrodes 20 and second electrodes 30. The electrode pairs 91, 92 are arranged in an offset manner with respect to one another based on the circumference of the shaft 10. On the one hand, this makes it possible to increase the accuracy with which the rotational position and/or speed is/are determined. On the other hand, the direction of rotation of the shaft 10 can be additionally determined, in particular by capturing the sequence of the temporally offset change in the electric field EF by means of the first electrode pair 91 and the second electrode pair 92. Depending on the direction of rotation, a particular measuring elevation 14 causes a change in the electric field EF first of all with respect to the first electrode pair 91 and, in a temporally offset manner, with respect to the second electrode pair 92, from which the direction of rotation of the shaft 10 can be determined.

A measuring arrangement 100 according to the disclosure can be easily implemented and is suitable, in particular, for use for determining the rotational position, speed and/or direction of rotation of a shaft of an electric motor of electromotively adjustable devices of a vehicle, for example a sliding roof, a window lifter, an exterior mirror, a seat, convertible roof or a locking mechanism.

It should be pointed out at this point that all aspects of the disclosure which have been described above are claimed as being essential to the disclosure alone and in any combination, in particular the details illustrated in the drawings. A corresponding situation applies to the method steps explained. Modifications thereof are familiar to a person skilled in the art.

### LIST OF REFERENCE SIGNS

10 Shaft
11 Measuring section
12 Shaft axis
13 Shaft profile
14 Radial measuring elevation
20 First electrode
21 Conductor track
30 Second electrode
31 Conductor track
40 Evaluation unit
50 Printed circuit board
51 Measuring recess
60 Voltage source
70 Microcontroller
80 Filter unit
91 First electrode pair
92 Second electrode pair
100 Measuring arrangement
EF Electric field
PM Central plane
PE Electrode plane

1. Measuring arrangement for determining the rotational position,
speed and/or direction of rotation of a shaft of an electric motor of an electromotively adjustable device of a vehicle, comprising:
at least one first electrode and at least one second electrode which each form capacitor elements,
wherein an electrical voltage can be applied to the at least one first and at least one second electrodes in such a manner that the at least one first and at least one second electrodes generate an electric field (EF);
a rotatable shaft having a measuring section which has an out-of-roundness,
wherein the measuring section is arranged relative to the at least one first and at least one second electrodes in such a manner that a rotation of the shaft changes the electric field (EF);
an evaluation unit which is conductively connected to an electrode and is designed to capacitively capture a change in the electric field (EF), in particular in the form of a change in a voltage applied to an electrode.

2. Measuring arrangement according to claim 1, wherein at least first and second electrode pairs each comprising at least one first and at least one second electrodes are provided, wherein the first electrode pair is designed to determine the rotational position and/or speed of the shaft and the second electrode pair is designed to determine the direction of rotation of the shaft.

3. Measuring arrangement according to claim 1, wherein the measuring section of the shaft has a shaft profile which is not rotationally symmetrical.

4. Measuring arrangement according to claim 1, wherein the shaft profile has radial measuring elevations distributed over the circumference.

5. Measuring arrangement according to claim 1, wherein at least two measuring elevations extend to a different degree in the radial direction.

6. Measuring arrangement according to claim 1, wherein the shaft profile is a toothed profile or a polygonal profile, wherein the shaft profile has 2 to 16 radial measuring elevations.

7. Measuring arrangement according to claim 1, wherein the shaft axis is arranged parallel to a central plane (PM) of the at least one first and at least one second electrodes, preferably perpendicular to an electrode plane (PE) in which the at least one first and at least one second electrodes are arranged.

8. Measuring arrangement according to claim 1, wherein the measuring arrangement comprises a printed circuit board on which the electrodes are arranged.

9. Measuring arrangement according to claim 8, wherein the printed circuit board has a measuring recess, wherein the measuring section of the shaft extends into the measuring recess.

10. Measuring arrangement according to claim 1, wherein the measuring arrangement comprises a microcontroller which is designed to supply at least one of the at least one first and at least one second electrodes with a DC voltage.

11. Measuring arrangement according to claim 1, wherein the evaluation unit comprises a filter unit which is designed to allow a frequency band of a captured measurement signal to pass through.

12. Measuring arrangement according to claim 1, wherein the measuring section is electrically conductive.

13. Measuring arrangement according to claim 1, wherein the shaft is a motor output shaft of an electromotively adjustable device of a vehicle.

14. Method for determining the rotational position, speed and/or direction of rotation of a shaft of an electric motor of an electromotively adjustable device of a vehicle, comprising the following steps:
a) providing at least one first electrode and at least one second electrode which each form capacitor elements;
b) applying a voltage to the at least one first and at least one second electrodes in order to generate an electric field;
c) rotating a shaft which has a measuring section with an out-of-roundness,
wherein the measuring section is arranged relative to the electrodes in such a manner that a rotation of the shaft changes the electric field (EF);
d) capturing the change in the electric field (EF) by means of a capacitive measurement using an evaluation unit which is conductively connected to at least one of the at least one first and second electrodes by capturing a change in a voltage applied to the at least one of the at least one first and second electrodes;
e) determining the rotational position, speed and/or direction of rotation of the shaft with the evaluation unit on the basis of the captured change in the electric field (EF).

15. Use of a measuring arrangement according to claim 1 for determining the rotational position, speed and/or direction of rotation of a shaft of an electric motor of an electromotively adjustable device of a vehicle.

16. Measuring arrangement according to claim 1 wherein the measuring section of the shaft has a shaft profile which is point-symmetric with respect to the shaft.

17. Measuring arrangement according to claim 1 wherein the measuring section of the shaft has a shaft profile which is point-symmetric with respect to the shaft axis and has at least one radial measuring elevation.

18. Measuring arrangement according to claim 10, wherein the DC voltage is a pulsed DC voltage.

19. Measuring arrangement according to claim 1, wherein the shaft is a motor output shaft of at least one of a sliding roof, a window lifter, an exterior mirror, a seat, a convertible roof or a locking mechanism.

20. Measuring arrangement according to claim 1, wherein the shaft profile has radial measuring elevations uniformly distributed over the circumference.
